(19) United States
(12) Patent Application Publication
(10) Pub. No.: US 2009/0181741 A1
(43) Pub. Date: Jul. 16, 2009

(54) CARD GAME APPARATUS WITH CARD DISPLAYS

(76) Inventor: Shun-Tsung Hsu, Taichung (TW)

Correspondence Address: Hershkovitz & Associates, LLC, 2845 Duke Street, Alexandria, VA, 22314, US

(21) Appl. No.: 12/013,383

(22) Filed: Jan. 11, 2008

(51) Int. Cl. A63F 9/24; A63F 13/12

(52) U.S. Cl. 463/11; 463/31; 463/42; 463/39

(57) ABSTRACT

A card game apparatus with card displays has a gaming server apparatus, multiple client interfaces and multiple card displays. The gaming server apparatus runs a card game program, deals cards and sends card images to the card displays. Each client interface is electronically connected to the gaming server apparatus, displays status of the card game program to the players and accepts commands from the players to control the card game program. Each card display is a card like electric display and is controlled by the client interface to display the card image. The player can therefore glance at the card images shown on their card-like display for a more realistic card game simulation.

### BACKGROUND OF THE INVENTION

1. Field of Invention

The present invention relates to a card game apparatus, and more particularly to a card game apparatus with card displays.

2. Description of the Related Art

Consumer electronic technologies are widely used in entertainment industries. Many kinds of electronic game machines are provided. An electronic card game apparatus in a casino is popular because the electronic card game apparatus is fun and easy to use. Normally, the electronic card game apparatus comprises multiple client interfaces and a game server. A player sits in front of one of the client interfaces. The client interface accepts wagers from the player and receives images of cards dealt from the game server and displays the images to the player. Even though the electronic card game apparatus may be convenient to play, the player cannot hold, cover or interact with real cards during play thereby detracting from the fun and reality of holding real cards.

The present invention provides a card game apparatus with card displays to obviate or mitigate the shortcomings of the conventional electronic card game apparatus.

### SUMMARY OF THE INVENTION

The primary objective of the present invention is to provide a card game apparatus with card displays to improve entertainment and interaction of playing the card game apparatus.

The card game apparatus with card displays has a gaming server apparatus, multiple user interfaces and multiple card displays. The gaming server apparatus runs a card game program, deals cards and sends card images to the card displays. Each user interface is electronically connected to the gaming server apparatus, displays status of the card game program to the players and accepts commands from the players to change the status of the card game program. Each card display is a card like electric display and is controlled by the user interface to display the card image. The player can therefore squeeze and glance at the card image shown on the card-like display for a more realistic card game simulation.

Other objectives, advantages and novel features of the invention will become more apparent from the following detailed description when taken in conjunction with the accompanying drawings.

### BRIEF DESCRIPTION OF THE DRAWINGS

FIG. 1 is a block diagram of a card game apparatus with card displays in accordance with the present invention;

FIG. 2 is an operational top view of the card game apparatus in FIG. 1;

FIG. 3 is another operational top view of another embodiment of the card game apparatus in FIG. 1; and

FIG. 4 is a logic diagram of a card game program used in the card game apparatus in FIG. 1.

### DETAILED DESCRIPTION OF THE INVENTION

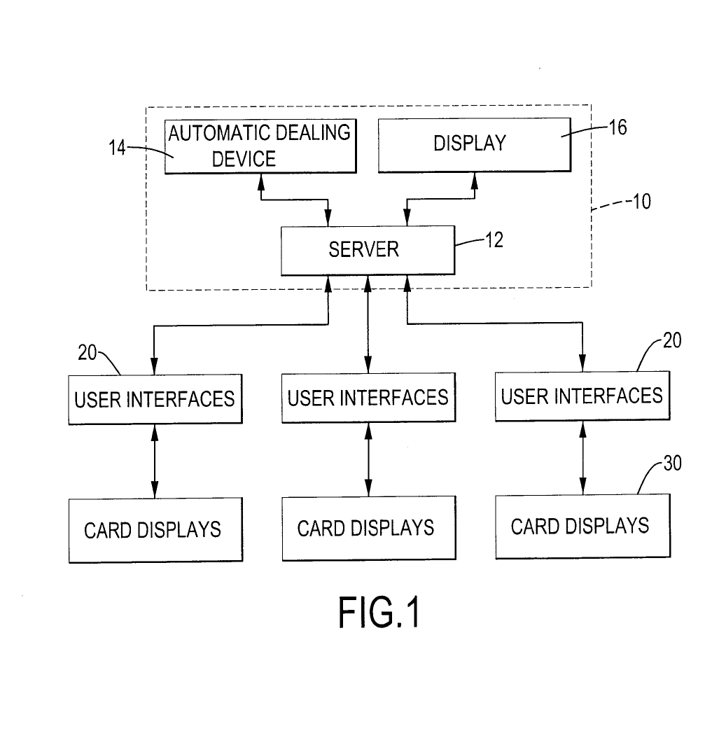

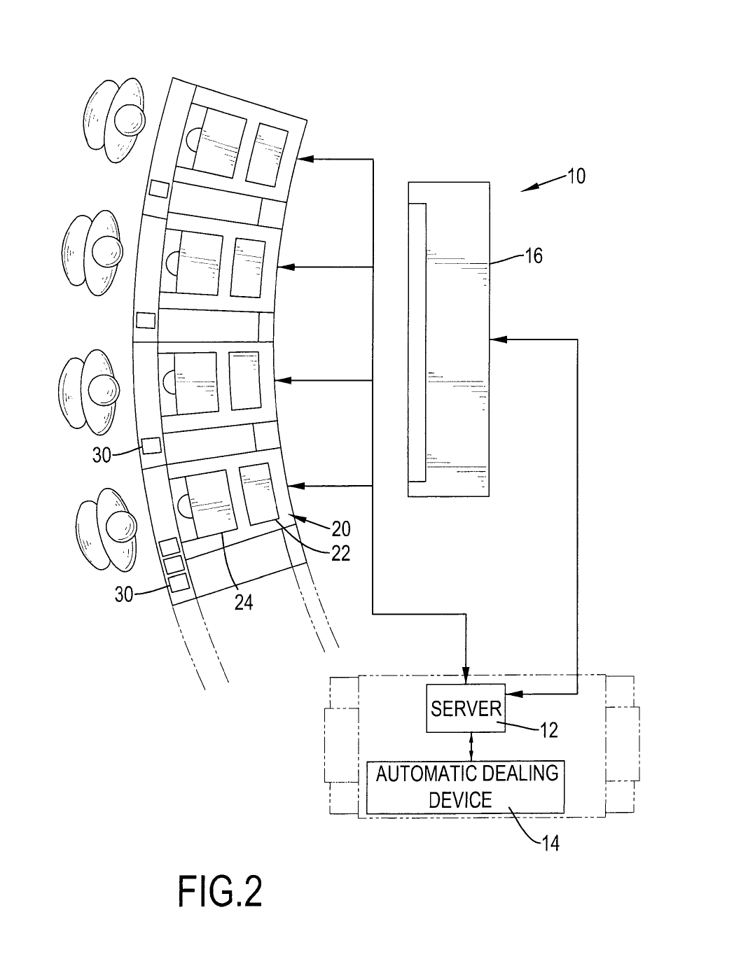

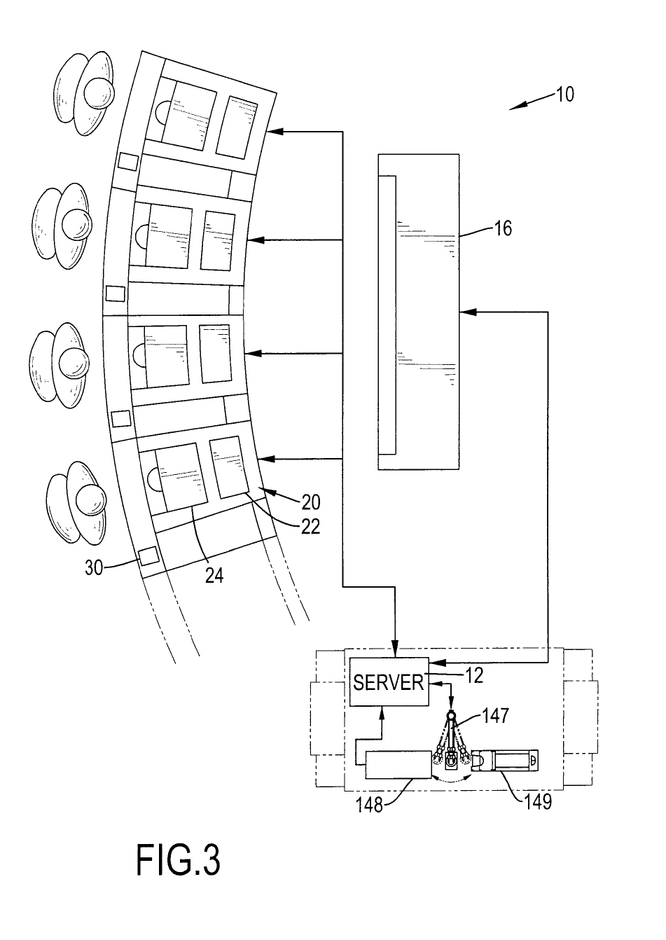

With reference to FIGS. 1, 2 and 3, a card game apparatus with card displays in accordance with the present invention comprises a gaming server apparatus (10), multiple user interfaces (20) and multiple card displays (30).

The gaming server apparatus (10) runs a card game program and may comprises a server (12), an automatic dealing device (14) and an optional display (16). The server (12) runs the card game program. The card game program may follow rules of poker, baccarat, blackjack, three cards porker, casino war, Texas holder or the like.

The automatic dealing device (14) is electronically connected to and controlled by the server (12), deals cards automatically, may identify card images after the cards are dealt, sends the card images to the server (12), and may be a card dealing robot (147) with a card image recognition (148). The card image recognition (148) may be an image recognition, a radio frequency identification (RFID) reader or the like. Further, the automatic dealing device (14) may be an automatic card dealing machine with an card image recognition, a drawing machine with an card image recognition, a random number generator or the like.

In a preferred embodiment of the present invention, the automatic dealing device (14) is a card dealing robot (147) with an image recognition having a card shoe (149) containing shuffled cards. The card dealing robot (147) is electronically connected to the server (12) and is controlled by the server (12) to draw cards from the card shoe (149) and moves drawn cards over the image recognition. The image recognition is electrically connected to the server (12), scans the drawn card being held by the card dealing robot (147) and generates an image corresponding to the drawn card after scanning and sends the image to the server (12). When the card image recognition (148) is a RFID reader, each card inside the card shoe (149) identically corresponds to and has a RFID tag, wherein, the RFID reader reads the RFID tag of the drawn card, generates an identified results corresponding to the drawn card and transmits the identified results to the server (12).

The display (16) is electrically connected to the server (12), is an electronic display such as a cathode ray tube display, flat panel display such as a liquid crystal display, plasma display or the like and displays status of the card game program.

The user interfaces (20) are electrically connected to the server (12), and each user interface (20) receives a status of the card game program from the server (12), accepts an inputted command from a player to change the status of the card game program, may be a touch screen device and may have an output interface (22) and an input interface (24).

The output interface (22) may be an electronic display that displays the status of the card game program to the player. The input interface (24) may be a keyboard, joystick or series of buttons that allows the players to change the status of the card game program. In the preferred embodiment of the present invention, the user interfaces (20) are touch screen devices which displaying the status of the card game program and accepting the inputted commands from the players by touching screen surfaces of the user interfaces (20).

Each card display (30) is connected electronically to the gaming server apparatus (10) may be connected through the server (12) or though the user interface (20), may be connected wirelessly or hardwired to the server (12), receives and displays the image corresponding to the drawn card sent from the server (12). The card display (30) is a flexible electronic display, may be an e-paper display, E-ink display, organic light emitting diode display, liquid crystal display or the like, and may be formed in size and shape of a poker card.

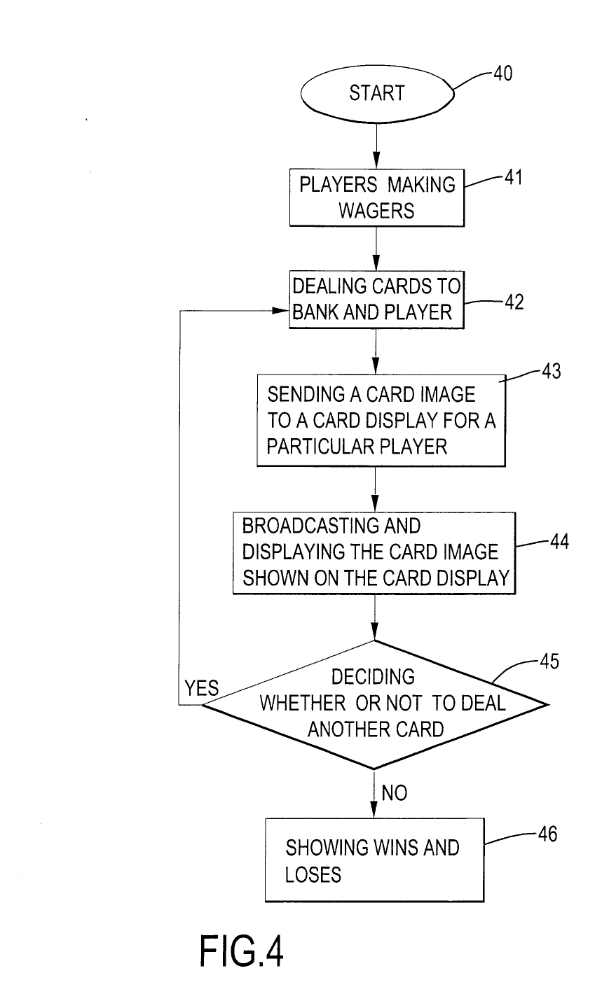

With further reference to FIG. 4, the card game program of the preferred embodiment of the present invention is a Baccarat poker game program with steps comprising players making wagers (41), dealing cards to BANK and PLAYER(42), sending a card image to a card display for a particular player(43), broadcasting and displaying the card image shown on the card display (44), deciding whether or not to deal another card (45) and showing wins and loses (46)

In the step of players making wagers (41), players buy into the round by wagering results including a BANK, a PLAYER or a TIE by using the corresponding user interface (20).

In the step of dealing cards to the BANK and PLAYER (42), the automatic dealing device (14) deals cards to the BANK and the PLAYER first, then sends images of the dealt cards to the server (12) after the cards are identified.

In the step of sending a card image to a card display (43), the server (12) selects the player (may be a player with a largest wager or whose turn is due) to send one of the images of the dealt cards to and sends the image to the selected player interface (20) or the card display (30) that displays the image for the player. A display side of the card display (30) may then be covered when the image is received allowing the player to squeeze and glance at the image shown on the display side and feel just like they are playing a real card game.

In the step of broadcasting and displaying the card image shown on the card display (44), the server (12) sends the image displayed on the card display (30) to all user interfaces (20) to display the image on the display (16) or the image is sent to all output interfaces (22) so that each player can view the card image.

In the step of deciding whether or not to deal another card (45), the server (12) decides whether to deal another card to the BANK or PLAYER depending on the cards dealt. If the BANK or PLAYER requires another card, the server (12) will then repeat the step of dealing cards to the BANK and PLAYER (42).

In the step of showing wins and loses (46), the server (12) judges whether the BANK or PLAYER is a winner or if a TIE situation has occurred and calculates winnings and losses of each player.

Even though numerous characteristics and advantages of the present invention have been set forth in the foregoing description, together with details of the structure and function of the invention, the disclosure is illustrative only. Changes may be made in detail, especially in matters of shape, size and arrangement of parts within the principles of the invention to the full extent indicated by the broad general meaning of the terms in which the appended claims are expressed.

What is claimed is:

1. A card game apparatus with card displays comprising
a gaming server apparatus running a card game program;
multiple user interfaces being electronically connected to the gaming server apparatus, and each user interface receiving a status of the card game program from the gaming server apparatus and accepting an inputted command from a player to change the status of the card game program; and
multiple card displays being controlled by the gaming server apparatus to receive and display a card image.

2. The card game apparatus as claimed in claim 1, wherein the card game program follows rules of baccarat, blackjack, three cards porker, casino war or Texas holder.

3. The card game apparatus as claimed in claim 1, wherein the gaming server apparatus has
a server running the card game program;
an automatic dealing device being electrically connected to and controlled by the server, dealing cards automatically and sending card images to the server; and
a display being electrically connected to the server and displaying status of the card game program.

4. The card game apparatus as claimed in claim 3, wherein the automatic dealing device has a card dealing robot and a radio frequency identification reader,
the card dealing robot is controlled by the server for drawing cards from a card shoe and moving drawn cards over the radio frequency identification reader;
each card identically corresponds to and has a radio frequency identification tag; and
the radio frequency identification reader is controlled by the server to read the RFID tag thereby generating an identified results corresponding to the drawn card and transmits the identified results to the server after the drawn cards moving over the radio frequency identification reader.

5. The card game apparatus as claimed in claim 1, wherein each card display is wirelessly connected to the gaming server apparatus.

6. The card game apparatus as claimed in claim 1, wherein each card display is hardwired to the gaming server apparatus.

7. The card game apparatus as claimed in claim 1, wherein each user interface has
an output interface being an electronic display displaying status of the card game program; and
an input interface allowing players to control the card game program.

8. The card game apparatus as claimed in claim 1, wherein each card display is selected from a group of an e-paper display, an E-ink display, an organic light emitting diode display and a liquid crystal display.

9. The card game apparatus as claimed in claim 1, wherein the card display is a flexible electrical display.

10. The card game apparatus as claimed in claim 3, wherein the automatic dealing device is selected from a group of a card dealing robot with an image recognition, an automatic card dealing machine with an image recognition, a drawing machine with an image recognition and a random number generator with an image recognition.

11. The card game apparatus as claimed in claim 3, wherein each user interface has
an output interface being an electronic display displaying status of the card game program; and
an input allowing players to control the card game program.

12. The card game apparatus as claimed in claim 10, wherein the card dealing robot with an image recognition further has a card dealing robot and an image recognition,
the card dealing robot is controlled by the server for drawing cards from a card shoe and moving drawn cards over the image recognition; and
the image recognition is controlled by the server to scan the drawn cards thereby generating an image corresponding to the drawn card before sending the image to the server.

13. The card game apparatus as claimed in claim 11, wherein the automatic dealing device is selected from a group of a card dealing robot with an image recognition, an automatic card dealing machine with an image recognition, a drawing machine with an image recognition and a random number generator with an image recognition.

14. The card game apparatus as claimed in claim 3, wherein each card display is selected from a group of an e-paper display, an E-ink display, an organic light emitting diode display and a liquid crystal display.

15. The card game apparatus as claimed in claim 3, wherein the card display is a flexible electrical display.

16. The card game apparatus as claimed in claim 14, wherein the card display is a flexible electrical display.

17. The card game apparatus as claimed in claim 14, wherein the card display is formed in size and shape of a poker card.
